(19) United States
(12) Patent Application Publication
(10) Pub. No.: US 2004/0225640 A1
(43) Pub. Date: Nov. 11, 2004

(54) Context searchable communications

(75) Inventors: Michael Wayne Brown, Georgetown, TX (US); Michael A. Paolini, Austin, TX (US); Newton James Smith JR., Austin, TX (US)

Correspondence Address: Marilyn Smith Dawkins, Intellectual Property Law Dept, IBM Corporation, 11400 Burnet Road, Austin, TX, 78758, US

(73) Assignee: International Business Machines Corporation, Armonk, NY (US)

(21) Appl. No.: 10/185,296

(22) Filed: Jun. 27, 2002

(51) Int. Cl. G06F 7/00

(52) U.S. Cl. 707/3

(57) ABSTRACT

A method, system, and program for storing context searchable communications are provided. Varying portions of the content of a communication are analyzed to identify a reaction response associated with each of the varying portions of the content. A displayable attribute is associated with each of the varying portions of the content to indicate the identified reaction response. Each of the varying portions of the content is stored for the communication with the identified reaction response and the associated displayable attribute in a database searchable by context comprising at least one of identified reaction responses and associated displayable attributes.

### BACKGROUND OF THE INVENTION

1. Technical Field

The present invention relates in general to messaging communications and, in particular, to storing a context of a message communication with the communication. Still more particularly, the present invention relates to searching stored communications according to the reaction responses specified within the communications.

2. Description of the Related Art

As the Internet and telephony expand, the ease of communications between individuals in different locations continues to expand as well. However, with contemporaneous or delayed electronic communications, much of the detectable content available during face-to-face conversation is reduced or eliminated.

During face-to-face conversation, typically more than just word based speech is communicated. “Verbal” and “non-verbal” information combined provide a context for the content of a communication. Verbal information may include, for example, sounds, voice tone, and volume. Non-verbal information may be exchanged, for example, via eye-contact, gestures, facial movements, and body language. For example, the speaker is able to watch the responses of the listener and gauge a responsive emotion to words spoken. In addition, the speaker may be able to watch the listener to receive non-verbal clues as to whether the listener understood the speaker's words. Further, the listener can watch the speaker's movements and tone to better understand the type of emotion that the speaker is trying to convey.

Without the elements of face-to-face communication, verbal and non-verbal information that provide the context for communication content is often lost or eliminated. Without these integral parts of communication, there is a greater chance of misunderstanding in communication. For example, there may be greater misunderstandings due to cultural differences which are not readily apparent when there is not face-to-face communication. Further, there may be misunderstandings as to the emotion with which a communication is made or received that are not quickly corrected without face-to-face, contemporaneous communication.

For example, an electronic mail (e-mail) message provides a valuable type of electronic communication, but not contemporaneous face-to-face communication. A person sending an e-mail message does not have the advantage of watching the recipient's body language in response to reading the electronic mail message to determine whether the recipient understood the communication. In addition, the recipient of an e-mail message may not be fully aware of the age, sex, ethnic background, rank, regional location, or other background information which might influence the way the sender chooses to communicate content. Further, the recipient does not have the benefit of viewing the sender to determine the emotional context in which the sender is writing the e-mail message. The sender might be only disappointed, but use words which the recipient associates with anger, leading to a misinterpretation of what the sender wrote.

Another limitation of electronic communications is that when such communications are stored, they are typically only searchable according to date or sender. Therefore, in view of the foregoing, it would be advantageous to provide a method, system, and program for indicating the context of an electronic communication within the electronic communication. Then, it would be advantageous to store the context of an electronic communication with the electronic communication, such that the electronic communication can later be located according to the context of the communication.

### SUMMARY OF THE INVENTION

In view of the foregoing, it is therefore an object of the present invention to provide improved messaging communications.

It is another object of the present invention to provide a method, system and program for storing a context of a message communication with the communication.

It is yet another object of the present invention to provide a method, system and program for searching stored communications according to the reaction responses specified within the communications.

According to one aspect of the present invention, varying portions of the content of a communication are analyzed to identify a reaction response associated with each of the varying portions of the content. A displayable attribute is associated with each of the varying portions of the content to indicate the identified reaction response. Each of the varying portions of the content is stored for the communication with the identified reaction response and the associated displayable attribute in a database searchable by context comprising at least one of identified reaction responses and associated displayable attributes.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts an embodiment of a computer system with which the method, system, and program of the present invention may be utilized;

FIG. 2 depicts a simplified block diagram of a client/server environment in which electronic messaging typically takes place in accordance with the method, system and program of the present invention;

FIG. 3 depicts a block diagram of a messaging system server in accordance with the method, system, and program of the present invention;

FIG. 4 depicts a block diagram of a reaction response controller and the responses database accessed by the reaction response controller in accordance with the method, system, and program of the present invention;

FIG. 5 depicts a block diagram of a message storage controller in accordance with the method, system, and program of the present invention;

FIG. 6 depicts an illustrative representation of analysis preferences in accordance with the method, system, and program of the present invention;

FIG. 7 depicts an illustrative representation of an individual response profile in accordance with the method, system, and program of the present invention;

FIG. 8 depicts an illustrative representation of a regional response profile in accordance with the method, system, and program of the present invention;

FIG. 9 depicts an illustrative embodiment of a National Language Support profile in accordance with the method, system, and program of the present invention;

FIG. 10 depicts an illustrative representation of a proposed e-mail in accordance with the method, system, and program of the present invention;

FIG. 11 depicts an illustrative representation of a context searchable e-mail file stored in accordance with the method, system, and program of the present invention;

FIG. 12 depicts an illustrative representation of a database sorted by reaction response in accordance with the method, system and program of the present invention; and

FIG. 13 depicts a high level logic flowchart of a process and program for context-based searching and storage of communications.

### DETAILED DESCRIPTION OF THE PREFERRED EMBODIMENT

A method, system, and program for storing and searching communications according to the reaction responses designated in the communication are provided. In a preferred embodiment, the reaction responses are indicated according to color within the communication. However, in alternate embodiments, the reaction responses may also be indicated through other displayable attributes such as text, graphics, icons, images, or sounds, as will be understood by one skilled in the art. Text may be varied in font, font size, font style, subscript, superscript, and other text treatments to indicate reaction responses. In addition, semi-transparent overlays, gradient bars, and other graphical elements may be used to indicate reaction responses.

Communications may include, but are not limited to, documents, electronic communications, voice communications, video communications, graphical communications, and other communications via graphics-based media. Documents may include, but are not limited to, text documents, manuscripts, book texts, software code, and other types of alphanumeric and graphical based files. Electronic communications may include, but are not limited to, electronic mail (e-mail), instant messaging, chat room communications, two-way text messaging, speech-to-text messaging, vibration-to-vibration messaging, and other network-enabled communications. Voice communications may include voice messaging, telephone communications, teleconferencing, and other voice based communication methods. Video communications may include, but are not limited to, video-conferencing, video messaging and other video based communication methods.

In a preferred embodiment of the present invention, communications are transferred from at least one sender to at least one recipient via a network. However, communications may also be transferred via a data storage medium or other platform. Further, communications via a network may be contemporaneous or delayed.

The content of any of the types of communications may include, but are not limited to, text, icons, video images, sound, graphics, avatar gesturing and other types of outputs. According to an advantage of the present invention, a context for the content of a communication is provided by the reaction responses for that content.

Reaction responses may be analyzed for a selected portion of a communication, varying portions of a communication, the whole communication, or multiple communications, for example. Reaction responses may be identified for a selected portion of a communication, varying portions of a communication, the whole communication, or multiple communications.

Reaction responses may include, but are not limited to, the anticipated response of a recipient, the intended response of the sender, and the actual response by the recipient. A sender may be provided with anticipated responses of the recipient for a proposed communication. In addition, the sender may provide intended responses for a proposed communication or an analysis of the content of the communication may render intended responses. The anticipated responses and/or intended responses may be sent with the communication to provide additional context for the recipient. In addition, the recipient may indicate actual responses to a communication. The actual responses may be catalogued and stored and/or returned with the communication to the sender.

The content of the communication and the reaction responses to a communication together provide a context for the communication that enhances the verbal and non-verbal communication that is lost when communicating via electronic media. The context preferably provides the sender and recipient with enhanced understanding of the intent of the content and the manner in which that content is understood.

The context of the communication is preferably stored with the communication, such that the communication is searchable according to the reaction responses designated in the communication. Advantageously, a database of communications stored according to context is searchable by reaction responses, colors indicating reaction responses, senders, recipients, times, dates, and other criteria.

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### Hardware Overview

The present invention may be executed in a variety of systems, including a variety of computing systems and electronic devices under a number of different operating systems. In one embodiment of the present invention, the computing system is a portable computing system such as a notebook computer, a palmtop computer, a personal digital assistant, a telephone or other electronic computing system that may also incorporate communications features that provide for telephony, enhanced telephony, messaging and information services. However, the computing system may also be, for example, a desktop computer, a network computer, a midrange computer, a server system or a mainframe computer. Therefore, in general, the present invention is preferably executed in a computer system that performs computing tasks such as manipulating data in storage that is accessible to the computer system. In addition, the computer system preferably includes at least one output device and at least one input device.

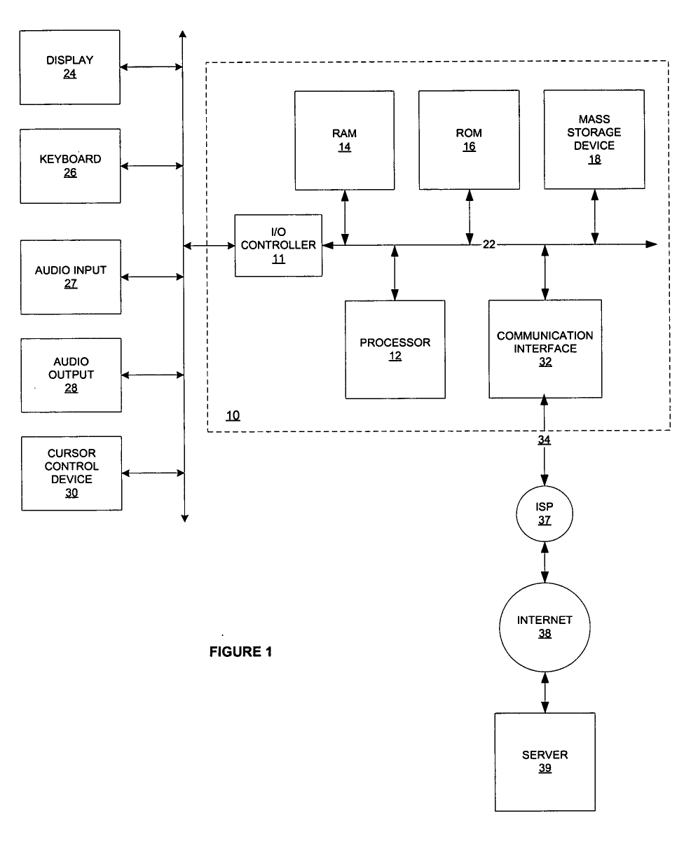

Referring now to the drawings and in particular to FIG. 1, there is depicted one embodiment of a computer system with which the method, system and program of the present invention may advantageously be utilized. Computer system 10 includes a bus 22 or other communication device for communicating information within computer system 10, and at least one processing device such as processor 12, coupled to bus 22 for processing information. Bus 22 preferably includes low-latency and higher latency paths that are connected by bridges and controlled within computer system 10 by multiple bus controllers.

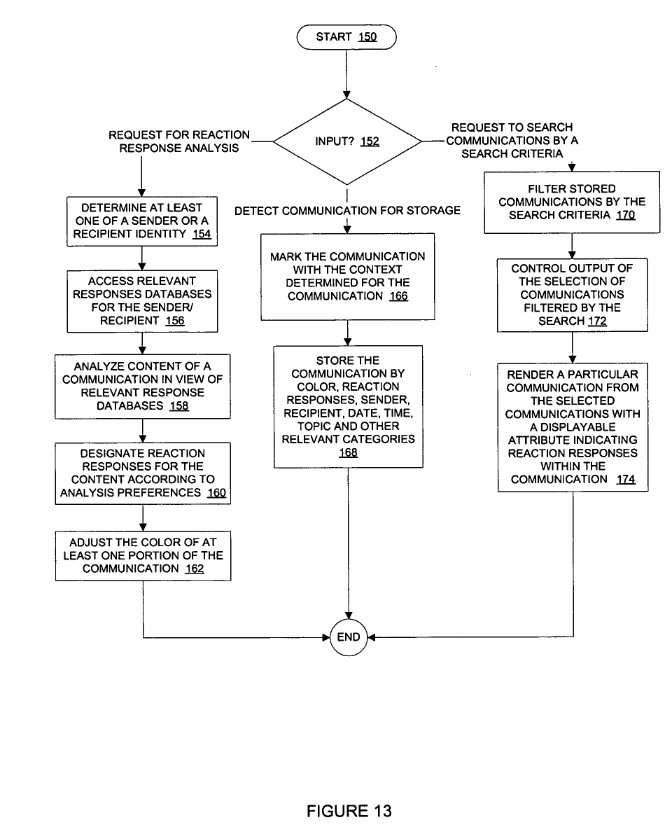

Processor 12 may be a general-purpose processor such as IBM's PowerPC™ processor that, during normal operation, processes data under the control of operating system and application software stored in a dynamic storage device such as random access memory (RAM) 14 and a static storage device such as Read Only Memory (ROM) 16. The operating system preferably provides a graphical user interface (GUI) to the user. In a preferred embodiment, application software contains machine executable instructions that when executed on processor 12 carry out the operations depicted in the flowchart of FIG. 13, and others described herein. Alternatively, the steps of the present invention might be performed by specific hardware components that contain hardwired logic for performing the steps, or by any combination of programmed computer components and custom hardware components.

The present invention may be provided as a computer program product, included on a machine-readable medium having stored thereon the machine executable instructions used to program computer system 10 to perform a process according to the present invention. The term “machine-readable medium” as used herein includes any medium that participates in providing instructions to processor 12 or other components of computer system 10 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of a non-volatile medium is mass storage device 18. Volatile media include dynamic memory such as RAM 14. Transmission media include coaxial cables, copper wire or fiber optics, including the wires that comprise bus 22. Transmission media can also take the form of acoustic or light waves, such as those generated during radio frequency or infrared data communications.

Moreover, the present invention may be downloaded as a computer program product, wherein the program instructions may be transferred from a remote computer such as a server 39 to requesting computer system 10 by way of data signals embodied in a carrier wave or other propagation medium via a network link 34 (e.g., a modem or network connection) to a communications interface 32 coupled to bus 22. Communications interface 32 provides a two-way data communications coupling to network link 34 that may be connected, for example, to a local area network (LAN), wide area network (WAN), or as depicted herein, directly to an Internet Service Provider (ISP) 37. In particular, network link 34 may provide wired and/or wireless network communications to one or more networks.

ISP 37 in turn provides data communication services through the Internet 38 or other network. Internet 38 may refer to the worldwide collection of networks and gateways that use a particular protocol, such as Transmission Control Protocol (TCP) and Internet Protocol (IP), to communicate with one another. ISP 37 and Internet 38 both use electrical, electromagnetic, or optical signals that carry digital data streams. The signals through the various networks and the signals on network link 34 and through communication interface 32, which carry the digital data to and from computer system 10, are exemplary forms of carrier waves transporting the information.

Further, multiple peripheral components may be added to computer system 10, connected to an input/output (I/O) controller 11 coupled to bus 22. For example, an audio input 27 is attached to I/O controller 11 for controlling audio input through a microphone or other sound or lip motion capturing device. An audio output 28 is attached to I/O controller 11 for controlling audio output through a speaker or other audio projection device. A display 24 is also attached to I/O controller 11 for providing visual, tactile or other graphical representation formats. A keyboard 26 and cursor control device 30, such as a mouse, trackball, or cursor direction keys, are coupled to I/O controller 11 as interfaces for user inputs to computer system 10. In alternate embodiments of the present invention, additional input and output peripheral components may be added.

### Messaging Systems Context

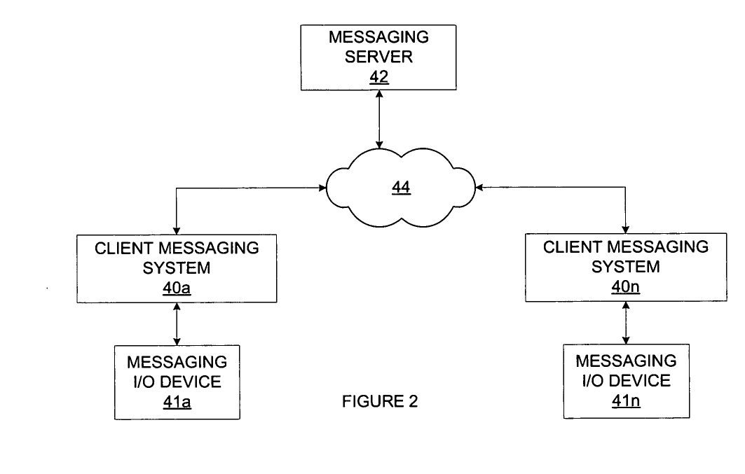

With reference now to FIG. 2, there is depicted a simplified block diagram of a client/server environment in which electronic messaging communication typically takes place in accordance with the method, system, and program of the present invention. The client/server environment is implemented within many network architectures. For example, the architecture of the World Wide Web (the Web) follows a traditional client/server model environment.

The terms “client” and “server” are used to refer to a computer's general role as a requester of data (the client) or provider of data (the server). In the Web environment, web browsers such as Netscape Navigator typically reside on client messaging systems 40a-40n and render Web documents (pages) served by at least one messaging server such as messaging server 42. Additionally, each of client messaging systems 40a-40n and messaging server 42 may function as both a “client” and a “server” and may be implemented utilizing a computer system such as computer system 10 of FIG. 1. Further, while the present invention is described with emphasis upon messaging server 42 controlling a messaging session, the present invention may also be performed by client messaging systems 40a-40n engaged in peer-to-peer network communications via a network 44.

The Web may refer to the total set of interlinked hypertext documents residing on servers all around the world. Network 44, such as the Internet, provides an infrastructure for transmitting these hypertext documents between client messaging systems 40a-40n and messaging server 42. Documents (pages) on the Web may be written in multiple languages, such as Hypertext Markup Language (HTML) or Extensible Markup Language (XML), and identified by Uniform Resource Indicators (URIs) that specify the particular messaging server 42 and pathname by which a file can be accessed, and then transmitted from messaging server 42 to an end user utilizing a protocol such as Hypertext Transfer Protocol (HTTP). Web pages may further include text, graphic images, movie files, and sounds, as well as Java applets and other small embedded software programs that execute when the user activates them by clicking on a link. While network 44 is described with reference to the Internet, network 44 may also operate via a WAN or LAN.

A sender enters a message via one of messaging I/O devices 41a-41n for a messaging session at a client messaging system such as client messaging system 40a. The message entry is transmitted to messaging server 42. Messaging server 42 then distributes the message entry to the users participating in the messaging session or to a particular recipient via network 44.

Advantageously, a sender may propose a message to be sent to the other users participating in the messaging session or to a particular recipient. Messaging server 42 analyzes the proposed message to identify an anticipated response associated with the content of the proposed message. The anticipated response is then identified and marked by color in the proposed message which may be viewed with an I/O device. An anticipated response may be indicated for each user participating in the messaging session, for the group of users, or for a particular recipient. The anticipated response may be attached with the message by messaging server 42 when delivered to the recipient client messaging system. Anticipated responses may be determined by messaging server 42 by analyzing the content of the message in view of responses catalogued for the recipient individually, regionally, nationally, and according to other criteria.

The sender may edit the content of the proposed message to achieve a desired anticipated response before sending the message to the recipient. General editing suggestions are provided by messaging server 42. In addition, the sender may specify an intended response to the proposed message and request specific editing suggestions from messaging server 42 that would make the anticipated response for the message the same as or similar to the intended response.

The sender may indicate overall intended responses for a message that are identified in the message by color. For example, the sender may indicate that the sender's mood in writing the message was happy. The color of the background of the message may be tinted yellow to indicate the happy mood.

In addition, the sender may select portions of the message and indicate an intended response to each of the sections. For example, the sender may indicate the greeting is intended to be cordial, the first paragraph is informative, the second paragraph is written with fervor, and the closing is intended to be respectful, where the intended responses are then color coded within the message.

Intended responses may also be determined by messaging server 42 by analyzing the content of the message in view of responses catalogued for the sender individually, regionally, nationally, and according to other criteria. These intended responses may be identified by color within the message and may be combined with other intended responses specifically designated by the sender. In addition, the colorings used to indicate intended responses as determined by messaging server 42 may be distinguished from those intended responses specifically designated by the sender.

When messaging server 42 transfers messages to client messaging systems 40a-40n for output to recipients in the messaging session, the message may include coloring indicating the anticipated responses analyzed by messaging server 42 that may or may not have been provided to the sender and the intended responses of the sender. The recipient may choose whether the I/O device receiving the message will display colorings.

In addition, messaging server 42 may request that the recipient indicate actual responses to a message. The recipient may indicate an overall actual response or actual responses to varying portions of the message. For example, a recipient may indicate an overall mood in which the recipient reads the message, the response that the recipient has to the overall message, and then a reaction to different parts of the message, such as particular icons or wording. Messaging server 42 may transmit the actual responses to the message back to the sender, such that the sender may respond to the actual responses.

Messaging server 42 may store each message communication according to the context of the communication, including the anticipated responses, intended responses, actual responses, and coloring associated therewith. The database of stored message communications is preferably searchable according to reaction responses, colors indicating reaction responses, senders, recipients, time, date, and other relevant criteria that are stored in association with the communication.

While in the present embodiment messaging server 42 handles analysis of anticipated responses and tracking of intended and actual responses, in alternate embodiments, reaction response information may be analyzed and indicated by a messaging reaction controller operating on client messaging systems 40a-40n. Further, messaging server 42 may incorporate multiple integrated systems for performing analysis of messages. As will be understood by one skilled in the art, other types of messaging systems may implement the present invention.

In addition, while in the present embodiment, transmission of a communication is described with reference to a contemporaneous or a delayed messaging system platform, in alternate embodiments, other types of platforms may support messaging and other types of communications. For example, communications are transmittable via traditional wireline telephone networks, wireless networks, data storage media, and other platforms for transmission of information.

Moreover, while in the present embodiment, messaging server 42 handles storage of message communications according to context, in alternate embodiments, storage of message communications according to context may be performed by any of client messaging systems 40a-40n or other computing systems implementing communications.

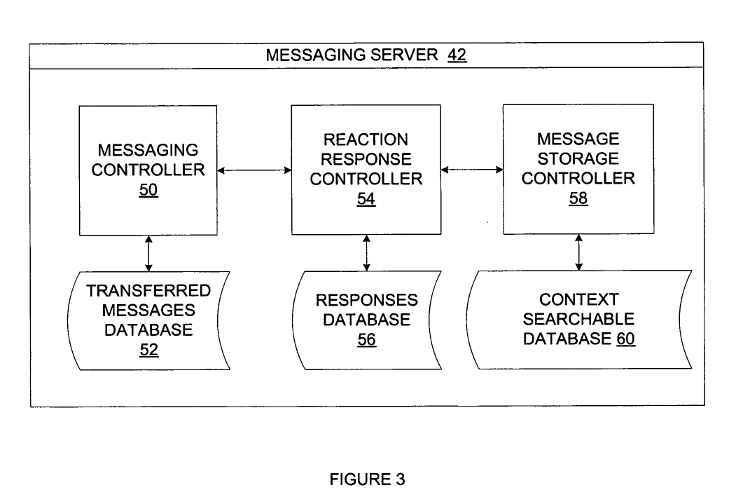

Referring now to FIG. 3, there is depicted a block diagram of a messaging system server in accordance with the method, system, and program of the present invention. As illustrated, messaging server 42 includes multiple controllers and databases located within a single server system or within multiple server systems, where the multiple server systems are integrated or accessible via network 44.

A messaging controller 50 preferably controls the distribution of message communications for the messaging system provided by messaging server 42. For purposes of the present invention, messaging controller 50 will be described with respect to message communications such as instant messaging, e-mail messaging or chat room messaging; however messaging controller 50 may control many types of available communications.

Messaging controller 50 distributes message communications from at least one sender to at least one recipient according to the type of messaging selected by the sender. For example, if a sender is participating in a chat room session, then the message communication is sent to other users participating in the channel opened by messaging controller 50 for the chat session. In another example, if a sender is sending an e-mail message, then the message communication is routed to the server that handles e-mail for the identified recipient(s). Senders and recipients are preferably represented by an identifier, such as a screen name, an e-mail address, or other network identifier; however senders and recipients may be anonymous, grouped, or otherwise identified.

Message communications transferred between at least one sender to at least one recipient as controlled by messaging controller 50 are preferably stored in transferred messages database 52 for a specified period of time. For an instant messaging session or a chat room session, all the entries for the session are preferably catalogued together within messages database 52.

A reaction response controller 54 analyzes message communications to determine reaction responses. To analyze reaction responses, reaction response controller 54 preferably accesses a responses database 56 which includes databases of responses catalogued individually, nationally, regionally, and according to other criteria. For output of the communication, coloring or other displayable attributes are added to the content of the communication to indicate reaction responses.

A message storage controller 58 controls storage and access to stored message communications. Preferably, message communications are stored with color and/or reaction responses specified in context searchable database 60. In particular, the reaction responses stored in context searchable database 60 are preferably searchable according to type of reaction response, color identifying a reaction response, sender, recipient, time, date, and other criteria.

Transferred messages database 52, responses database 56, and context searchable database 60 are accessible by messaging server 42 internally, externally, and via a network. In addition, transferred messages database 52, responses database 56, and context searchable database 60 may each be distributed across multiple database storage systems accessible via a network or located within a single data storage system.

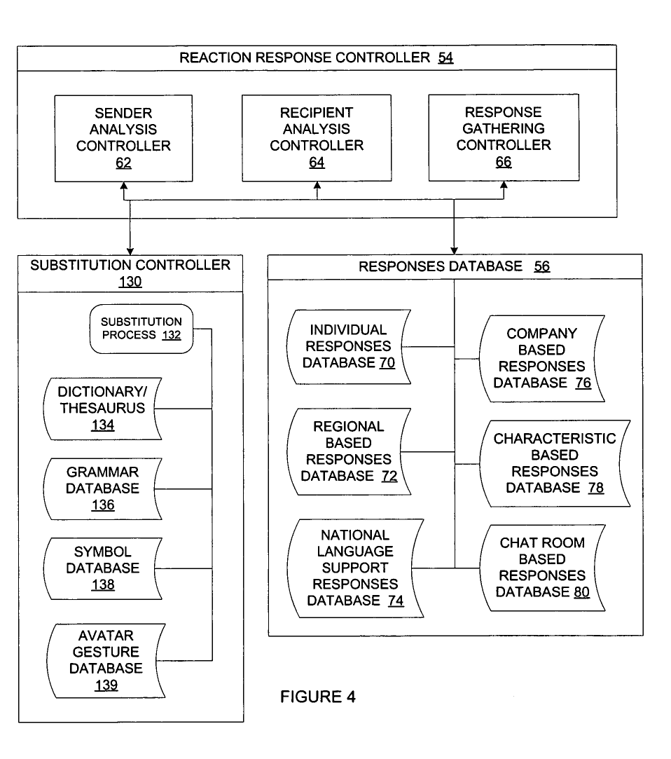

With reference now to FIG. 4, there is depicted a block diagram of a reaction response controller and the responses database accessed by the reaction response controller in accordance with the method, system, and program of the present invention. As depicted, reaction response controller 54 includes a sender analysis controller 62, a recipient analysis controller 64, and a response gathering controller 66. Each of the controllers may access responses database 56 via a network link or hardwired link.

Sender analysis controller 62 preferably performs reaction response analysis for the sender of a message communication. According to one function, sender analysis controller 62 analyzes a proposed message communication and indicates anticipated responses to the message communication to the sender. According to another function, sender analysis controller 62 recommends adjustments to a proposed message communication. Also, sender analysis controller 62 analyzes the message communication and indicates the sender's intended responses to a message communication. Further, sender analysis controller 62 detects intended responses specifically designated by a sender and attaches all the intended responses to the message communication.

In addition, for sender analysis controller 62 to recommend suggestions for adjustment of a proposed message, sender analysis controller 62 accesses a substitution controller 130. Substitution controller 130 includes a substitution process 132 that determines a range of substitutions for a portion of the content of a proposed message communication. In particular, substitution controller 130 includes, but is not limited to, a dictionary and thesaurus 134 for word adjustment suggestions, a grammar database 136 for grammatical adjustment suggestions, a symbol database 138 for symbol adjustment suggestions, and an avatar gesture database 139 for avatar gesture adjustment suggestions. Substitution controller 130 further accesses responses database 56, as will be further described, to retrieve anticipated and intended responses for different types of content so that suggestions can be tailored according to such reaction responses.

Recipient analysis controller 64 preferably performs reaction response analysis for the recipient of a message communication. According to one function, recipient analysis controller 64 analyzes a received message communication and indicates anticipated responses and intended responses marked within the received message communication. In addition, recipient analysis controller 64 may analyze a received message communication to determine the intended responses of the sender.

According to another function, recipient analysis controller 64 requests the recipient to provide actual responses to the message communication. Actual responses may be selected by the recipient highlighting the message in colors indicating a particular response, by entering words describing a response, and by detection of biometrics, such as a heart rate. Further, recipient analysis controller 64 may control return of the actual responses to the sender, enabling the sender to receive additional communication about how the message communication is understood by the recipient.

In analyzing a message communication to determine reaction responses, sender analysis controller 62 and recipient analysis controller 64 preferably encode the communication to include the reaction responses. The reaction response encoding preferably indicates whether there is an anticipated, intended or actual response, the response description, and a displayable attribute assigned to that response, such as a color. However, the encoding may solely indicate the response description or may solely encode the communications with colors to indicate responses.

In analyzing messages for reaction responses, sender analysis controller 62 accesses responses database 56. Responses database 56 includes multiple databases which may be independent of or integrated into one another. In addition, the multiple databases may be located within a single data storage location or distributed across multiple data storage systems linked by network link or hardwired link.

Identifiers for a sender and a recipient of a communication are included within the communication. From the sender and recipient identifiers, a personal profile may be accessed. Personal profile information may include, but is not limited to, name, regional areas of origin, national language, company association, memberships, and personal characteristics.

The computing systems utilized by the sender and recipient to communicate may store personal profiles that are accessible to reaction response controller 54. A network service provider may store a personal profile for each customer identifier accessible to reaction response controller 54. In addition, a personal identification database accessible via a network may store personal profiles according to identifiers. Layers of security and requirements for access to personal profiles may be provided by each of the computing systems storing personal profiles.

Examples of databases that are components of responses database 56 include, but are not limited to, individual responses database 70, regional based responses database 72, National Language Support (NLS) responses database 74, company based responses database 76, characteristic based responses database 78, and chat room based responses database 80.

Individual responses database 70 stores responses for an individual. Anticipated responses for a particular individual are gathered from actual responses by an individual to previous message communications. In addition, anticipated responses for a particular individual are gathered from pre-recorded responses to sample content by an individual. Further, an individual's schedule may be accessed to anticipate responses based on location, activities, recent sleeping or eating (or lack thereof), and other schedule factors that may aid in anticipating responses to particular types of content.

Intended responses by an individual to a communication are gathered from sender-specified intended responses designated by the sender in previous communications. In addition, intended responses by an individual may be gathered from the pre-recorded responses for a particular individual to sample content.

Regional based responses database 72 stores intended and anticipated responses according to a region associated with the sender or recipient. Regional based responses preferably include region specific responses to words, colloquialisms, phrases, topics, and idioms. For example, the greeting “y'all” will generally not elicit a negative response from a resident of the South. However, a resident of the North may respond negatively to the use of the term. Intended responses are determined from regional based responses database 72 according to the regional area associated with the sender, while anticipated responses are determined from regional based responses database 72 according to the regional area associated with the recipient.

NLS responses database 74 stores responses according to the National Language Support standard. NLS lets applications support multiple languages and cultural conventions. Under NLS, each user selects a profile including a language, country, and cultural information. A typical function of an NLS system is interchanging date and time formats and currency symbols for display according to a user profile.

According to an advantage of the present invention, NLS is further utilized to determine reaction responses by anticipating how content of a communication will be interchanged according to the NLS profile of the recipient. Further, according to an advantage of the present invention, NLS is expanded to provide support for more than just cultural conventions. It is advantageous to also provide for actual language conventions. Therefore, NLS responses database 74 stores responses to language conventions such that where the content of a message is interchanged into another language based format, the language conventions are interchanged with the anticipated and intended meanings.

Company based responses database 76 stores responses according to company or other organization. Companies and organizations often have specific lingo used to refer to products, services, and personnel within the company or organization. In addition, within a corporate culture, there are typically approved topics and word choices while others are viewed negatively. Further, references to a particular project may vary from office to office. Database 76 preferably stores these product and service references and topics so that when employees are communicating with one another or a third party is communicating with an employee, company based anticipated responses and intended responses can be accessed and analyzed.

Characteristic based responses database 78 stores general responses according to personal characteristics. Personal characteristics may include, for example, a profile and preferences. For example, preferences may include music preferences, movie preferences, or food preferences. Each personal characteristic may have general responses associated therewith. General personal characteristic anticipated responses of a recipient may be further specified according to the characteristics of the recipient and the sender. Further, general personal characteristic intended responses of a sender may be further specified according to the characteristics of the recipient and the sender.

Chat room based responses database 80 stores responses for a particular chat room. Chat rooms are often associated with a particular topic. However, typically the type of conversation in a chat room and what is appropriate in the chat room are determined by those who frequent the chat room. Database 80 preferably stores the anticipated, intended and actual reactions to message communications within a chat room to determine future anticipated and intended responses for chat room communications. Frequent participants in a particular chat room may also set the types of responses that should be anticipated to the use of certain vocabulary, to particular topics, and during particular times of the day.

In addition to accessing responses database 56, reaction response controller 54 requests a record of the reaction responses stored for previous communications between the sender and a particular recipient from message storage controller 58. The previous communication history between a particular sender and a particular recipient is utilized to determine a weighted history value for the present communication. For example, a weighted history value between “0” and “100” may be assigned to the reaction response of each previous communication, where a value of “0” represents an extremely friendly note, a value of “50” represents a neutral note, and a value of “100” represents an extremely hostile note. An average of the previous communication history values is determined and indicated to the sender and recipient. The recipient may assign the value or the value may be determined by reaction response controller 54.

A sender may also access the weighted communication history values for collections of communications between others. For example, if the sender flamed the recipient in a communication to the recipient's boss a week ago, the sender can request the weighted communication history value for communications between the sender and the recipient since the date of the flame mail. A “flame” mail is typically one that indicates that the communication is sent with anger.

The average weighted communication history value for communications received by the recipient from the sender will give the sender further information about the frame of reference in which the recipient will read a future communication from the sender. Further, based on the average weighted communication history value, the sender may adjust a communication in an attempt to adjust the average weighted communication history value between the sender and the recipient. A business may provide incentives for employees to communicate with each other and with customers to achieve communications within a specified range of average weighted communication history values.

Sender analysis controller 62 is preferably accessible for voice-to-text translations which typically translate a dictated voice communication into a text communication. Preferably, in translating the communication from voice into text, sender analysis controller 62 detects body language and tone and encodes these reactions into the text, such that an enhanced reaction response is available.

While sender analysis controller 62 and recipient analysis controller 64 access response database 56 to analyze a current communication with the response criteria, response gathering controller 66 prompts senders and recipients with sample content and requests the senders and recipients to indicate responses to that content. The information gathered by response gathering controller 66 is distributed to responses database 56 for storage in the appropriate individual databases.

Sample content may be presented to a sender or recipient via multiple communication media. For example, response gathering controller 66 may automatically initiate a web page in response to detecting a particular action by a sender or recipient. Further, response gathering controller 66 may initiate an instant messaging session, electronic mail, chat room, text messaging, or other form of communication through which responses to selected content are requested and those responses are returned to response gathering controller 66 for analysis and storage.

An individual responding to sample content may designate preferred levels of privacy for the individual's responses. For example, an individual may designate that the responses are publicly available, semi-public to systems that have passed required criteria, semi-private to only other individuals, organizations, and companies specified by the individual, or privately available only to the individual, organization, or company specifically requesting responses to the sample content. In particular, for semi-public privacy, the network provider may require individuals, organizations, companies, and other network providers to prove that certain security and confidentiality infrastructure is in place to receive access to anticipated responses by individuals.

The sample content used by response gathering controller 66 may include, for example, the content of a proposed communication or the content of an already sent communication. An e-mail option may allow a sender to request that a proposed message be sent to a selection of intended recipients with a request for responses. Response gathering controller 66 utilizes the proposed message as sample content in a request for responses from the selection of intended recipients. The anticipated responses may be shared among the selection of intended recipients and the sender to determine what types of adjustments should be made to the content of the e-mail before transmission to the remaining intended recipients.

In addition, a company may provide sample content utilized by response gathering controller 66 to prompt and retrieve responses from employees, customers, and others, where the sample content is specific to types of content of communications that are typical and appropriate within the company. Responses from the company sample content may be stored in responses database 56 for access only by that company in analyzing communications initiated by employees of the company.

Further, an ISP may design sample content to gain anticipated responses from customers or anyone communicating with a customer through the service. In particular, an ISP may design sample content to determine the types of information that individual users and users in general consider as spam or other undesirable communications. Based on individual and general responses to sample content, the ISP is then better able to filter undesirable communications from reaching customers.

Sample content may be designed for a focus group to anticipate responses to a particular advertising communication before distribution to a wider audience. A focus group may include individuals who have agreed to be a part of the focus group and individuals who by market research are determined to fit the ideal characteristics of the focus group.

Response gathering controller 66 may monitor the travel of an individual and request the individual to update responses to sample content after travel in other regions. For example, when an individual who primarily works and lives in Texas is detected as traveling to New York, response gathering controller 66 may initiate a sample content communication to test whether the individual has changed anticipated and intended responses to certain types of content after exposure to the use of that content in another region. As will be understood by one skilled in the art, other types of sample content may be designed and distributed.

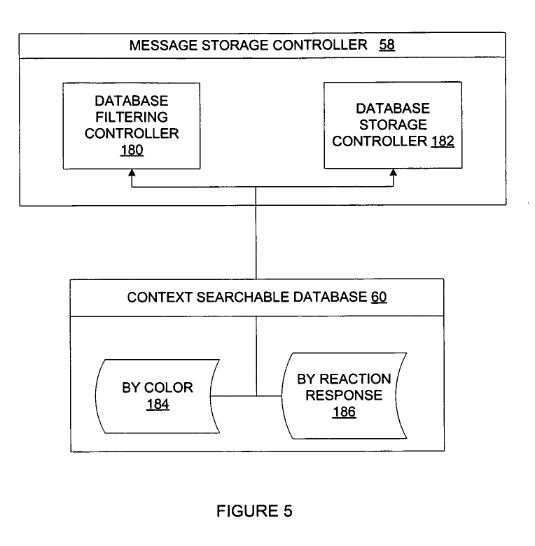

With reference now to FIG. 5, there is depicted a block diagram of a message storage controller in accordance with the method, system, and program of the present invention. As illustrated, message storage controller 58 includes a database filtering controller 180 and a database storage controller 182.

Database filtering controller 180 filters through context searchable database 60 according to search criteria such as a type of reaction response or a color identifying a reaction response. In addition, database filtering controller 180 may filter through context searchable database 60 according to other criteria, such as sender, recipient, time or date. Database filtering controller 180 may further sort the filtered search to order the relevant communication entries according to date, time, or other criteria.

For example, database filtering controller 180 may filter context searchable database 60 for communications received by a particular user with an overall anticipated reaction response of “friendly” and sent by a particular author or communicating concerning a particular subject. In another example, database filtering controller 180 may filter context searchable database 60 for communications sent by employees within a particular group within a particular time period with at least one portion of the communication including a “flame” intended response.

Database storage controller 182 controls storage of communications in context searchable database 60. Communications preferably include reaction response and colors indicating reaction responses. Where only colors indicating reaction responses are identified in a communication, database storage controller 182 may translate the colors into reaction responses for storage.

Context searchable database 60 is preferably searchable by multiple criteria, including color and reaction response. As an illustration, context searchable database 60 is divided into searchable criteria by color 184 and by reaction response 186. Other searchable criteria may be implemented in context searchable database 60.

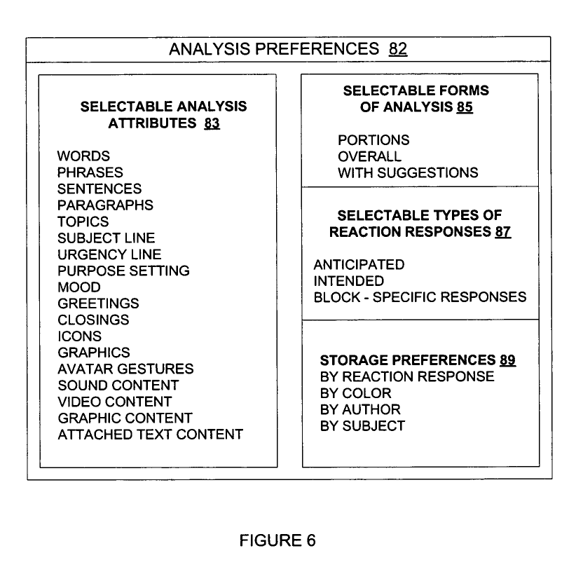

Referring now to FIG. 6, there is depicted an illustrative representation of analysis preferences in accordance with the method, system, and program of the present invention. Analysis preferences window 82 depicts examples of the types of content 83 that may be analyzed within a communication. Preferably, a sender or recipient may specify the types of response analysis of a message by selecting from among types of content 83.

First, the words within a communication may be compared with the anticipated responses to particular words specified in an individual responses database. In particular, where a communication is translated by a translation application, the translation application will compare anticipated responses to particular words with the sender's intended response to particular words in choosing how to translate those words.

In addition, it is advantageous to analyze the phrases of a communication. In particular, idioms within a single language may change rapidly by region such that speakers of a language in one region may not understand the meaning of an idiom spoken in another region or may have a different response than was intended to that idiom.

Analysis of entire sentences and paragraphs is advantageous. For example, a sender may indicate an overall intended response to an entire sentence or paragraph, rather than singling out individual words. Further, an analysis controller may determine the overall tone of a sentence or paragraph dependent upon the types of words and phrases within the sentences and paragraphs.

With each type of communication, there are unique characteristics of that communication that provide additional content for the communication. For example, in an e-mail, there is a subject line to be filled in by the sender. Often, recipients use the subject line to determine the order in which to open e-mails. Also, recipients may identify some types of subject lines as indicative of undesirable mail and automatically remove such e-mail from view. Advantageously, the subject line of a proposed e-mail may be analyzed to determine the anticipated response to such a subject line.

E-mail often has an additional attribute of an urgency setting. A sender may indicate whether a message is of regular importance or urgent or extremely urgent. Further, in the present invention, for an e-mail that needs to be read or responded to by a deadline, a user may indicate the timeliness urgency for an e-mail. When the e-mail shows up in the recipient's e-mail box, these urgency settings may be provided if supported. This setting enhances the content of an e-mail. However, what is extremely urgent to one person may only be of limited urgency to another, thus causing miscommunication or frustration. Further, it may be the habit of some senders to designate every e-mail as urgent, reducing the effectiveness of such as selection where a recipient realizes over time that e-mails from a particular sender will always be urgent.

In the present invention, communications are enhanced by providing purpose settings for any type of communication, in addition to the urgency settings that may be available in particular types of communications. A purpose setting allows a sender to indicate whether a communication is, for example, business, personal, or other type of purpose.

Further, the sender can indicate the general emotion or mood with which a communication is sent by analyzing the content of the communication or based on a sender selection. The framework under which an intended recipient will understand the purpose settings may be anticipated by analysis. A current mood for an intended recipient may be accessed from a mood designated by that intended recipient in the current communication or in another communication session.

A specific area of words and phrases analyzed may include greetings and closings. A proposed communication by an employee to a high-level executive may be analyzed, for example, to determine whether the greeting and closing of the proposed communication are sufficiently formal for that particular high-level executive. When a communication is received and the recipient selects for the communication to be translated, the greetings and closings are preferably translated according to the intended response of the sender to those greetings. For example, the sender may intend for the greeting and closing to be business respectful.

Additional content may be provided to a communication through graphics, sound, and video. Icons, such as emoticons, are often used in communications to indicate an emotion associated with a sentence. For example, a sentence that is a joke may be followed by a smiley face emoticon that would indicate to some readers that the sentence is a joke. However, the response of different recipients to different emoticons and other icons may vary widely by region, nation, expertise with Internet based communication, age, and other factors. A winking emoticon may be understood by one recipient as flirtatious and another recipient as joking.

Some types of communication provide graphical or video based avatars that represent participants in that communication. Typically, avatars are displayed in more instantaneous types of communications, such as instant messaging and chat rooms, but are not limited to those types of communications. Avatars typically make gestures, speak the text provided by each participant, and move around the display area during communication. Participants may select gestures that they would like avatars to make or the avatars may automatically make certain gestures from a selection of available gestures. Advantageously, a participant may select an intended emotion for the avatar to gesture. Further, in the present invention, the anticipated responses of certain participants to certain gestures may be determined and provided to the other participants, such that communications are enhanced.

Sound, video and graphic content provided in a communication are analyzed to determine responses. Sound content may include a voice mail, sound clip or other audio attachment. Anticipated and intended responses to sound content are performed by, for example, adjusting the tone of the sound, the volume of the sound, or other attributes of the sound to enhance meaning. Analysis of sound content may be performed by translating the sound content attachment into text and then analyzing the text. Further, video and graphic content may be translated and analyzed similarly. Video may also be analyzed by analyzing a rating associated with the video and by analyzing types of images within the video.

An advantageous function of electronic communications includes the function of attaching documents to a communication. For example, a sender may attach a text, sound, graphic, or video file with an e-mail message. Advantageously, the content of the attachment is analyzed by translating the attachment into a text equivalent if needed.

In addition, analysis preferences window 82 illustrates the forms 85 in which analysis may be output to the sender or recipient. For example, the sender or recipient may request to view the reaction responses by color for each portion of the content analyzed, the overall reaction response by color for the message, and the reaction responses with suggestions for adjustment. In addition, the sender or recipient may request to view the weighted communication history value for previous communications between the sender and the recipient or other collections of previous communications.

In determining an overall reaction response for a communication, a weighted history value for the current communication may be determined. In particular, each word, sentence, paragraph, page, chapter or other portion of the message is weighted by the previous words, sentences, paragraphs, pages, chapters and other portions of the message to determine whether the context of the current portions are changed by the content of the previous portions. For example, if the opening paragraph of a communication is hostile, the reaction response value assigned to the opening paragraph may weight the reaction responses determined for other paragraphs in view of the hostility of the opening paragraph, whereas by themselves the other paragraphs thereafter would not be read as hostile.

Further, analysis preferences window 82 illustrates the types of reaction response settings 87 that may be selected for output with a communication. A sender and a recipient may each specify which of the types of reaction response settings 87 to be output for a communication. For example, the sender may request output of anticipated responses, output of intended responses, and blocking of specific responses within the proposed message, but not others. In blocking specific responses, the recipient may request display of anticipated responses only. In addition, for example, a sender may specify that all reaction responses to icons within a communication are blocked from display.

Analysis preferences window 82 also depicts storage preferences 89. A sender and recipient may specify preferences for storage of a communication or for storage of communications in general. In particular, users may specify a preference to store communications according to multiple criteria including, but not limited to, reaction response, color, author, and subject.

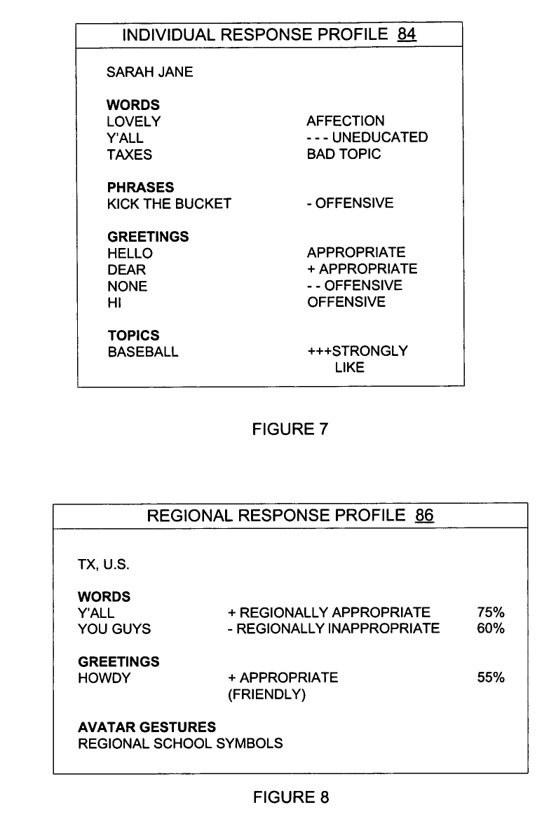

With reference now to FIG. 7, there is depicted an illustrative representation of an individual response profile in accordance with the method, system, and program of the present invention. As depicted, an individual response profile 84 is an example of responses stored for an individual within individual responses database 70.

Responses stored within individual response profile 84 may be gathered from actual responses and intended responses to communications. In addition, responses stored within individual response profile 84 may be gathered from an individual's responses to sample content.

In the example of individual response profile 84, an individual's responses to particular words, phrases, greetings, and topics are indicated. In alternate embodiments, responses to content within other categories of analysis may be indicated.

Misunderstandings in communication often arise when the content of a communication means one thing to one person and another thing to another. For example, this individual is offended by the phrase “kick the bucket”, however another individual's profile may indicate that individual considers that phrase humorous.

The responses displayed indicate a feeling associated with a type of content. In addition, positive (+) and negative (−) signs further describe the intensity of the feeling. For example, in addition to finding a lack of greeting offensive, the individual has indicated a double negative to indicate the intensity of offensiveness. In another example, the individual has indicated a triple positive, indicating a strong interest, in any communication with the topic of baseball. In addition to the types of response indicators depicted, other types of response indicators may be utilized. For example, thumbs up/thumbs down response indicators might be utilized.

In the example, the responses are assumed to apply to how an individual would respond as well as how the individual would intend for another to respond if the individual used the words in a communication. However, in alternate embodiments, an individual may specify that the individual would respond in one manner to receiving a communication with particular comment (the anticipated response), but would intend a different response if the same content was sent by the individual (the intended response).

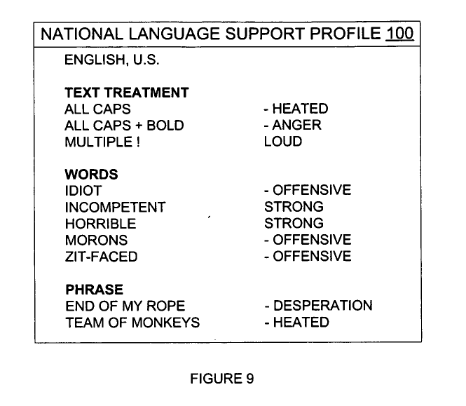

Referring now to FIG. 8, there is depicted an illustrative representation of a regional response profile in accordance with the method, system, and program of the present invention. As illustrated, a regional response profile 86 is an example of responses stored for a region within regional based responses database 72 for the regional area of Texas.

Responses stored within regional response profile 86 may be gathered from actual responses and intended responses to communications associated with the region. In particular, a broad range of communications may be analyzed to statistically determine general responses for a region. Further, the responses of individuals in a particular region to sample content may be analyzed to statistically determine general responses for a region. As illustrated, the statistical determinations are provided with each of the general responses.

Regions may be defined, for example, by specific geographical borders, city boundaries, county boundaries, state boundaries, country boundaries or continental boundaries. In addition, regions may be defined according to a characteristic, such as a “high-tech” region of all the individuals working in the high technology industry within a larger boundary, such as a state boundary.

Analyzing a communication in view of regional responses allows senders and recipients in differing regions to better communicate. For example, for the region depicted, the use of “howdy” as a greeting is appropriate and is connoted as a friendly greeting. If the sender is from the region depicted and the recipient is not, the recipient would receive a communication showing the intended response to the greeting as a response to receiving a friendly greeting.

Individuals within a region may differ with the general responses for that region. For example, the word “y'all” will generally not elicit a negative response from a resident of the South and therefore is generally regionally appropriate. However, a resident of the North may respond negatively to the use of the term.

Gestures are often given regionally-based meanings or exformation (shared knowledge between parties as to a meaning of a gesture that is lost on those who do not know the gesture has meaning). For example, most universities have a school cheer and a gesture associated with the cheer. Knowledge of university based gestures is typically regional, where universities who compete against one another know one another's gestures. Preferably, regional responses to these university based gestures are specified to add meaning to such gestures when performed by an avatar.

Referring now to FIG. 9, there is depicted an illustrative embodiment of a National Language Support profile in accordance with the method, system, and program of the present invention. As illustrated, a National Language Support profile 100 includes examples of responses stored based on a particular national language. National Language Support enables applications to support multiple languages and cultural conventions. Under NLS, each user selects a profile including a language, country, and cultural information. A typical function of an NLS system is interchanging date and time formats and currency symbols for display according to a user profile.

According to an advantage of the present invention, NLS is utilized to determine reaction responses by anticipating how content of a communication will be interchanged according to the NLS profile of the recipient. Further, according to an advantage of the present invention, NLS is expanded to provide support for more than just cultural conventions. It is advantageous to also provide for actual language conventions.

For example, National Language Support profile 100 provides an example of responses stored for a profile matching English as the language and the United States as the country. First, responses to types of text treatment are provided. Traditional NLS provides for interchanging fonts used depending on the user profile. However, the treatment of a font can provide additional communication. For the example profile, where words are in all-caps those words are typically received as a heated communication. Where words are in all-caps and bold, the words are typically received as a communication sent in anger. Further, use of multiple exclamation points typically implies that the phrase associated with the exclamation points is expressed in a “loud” manner. In particular if the communication were spoken, the speaker would speak the phrase followed by “!” at an elevated volume.

If the communication is interchanged into another language, preferably the responses associated with the text treatment are interchanged as well. For example, if there is a text treatment in the recipient's language that indicates a strong feeling associated with the words communicated, that text character or other symbol is interchanged. However, coloring language to indicate responses, where that coloring is interchangeable, is another way to indicate text treatment. Further, if the communication is received by another person with the same national profile, it is still advantageous to indicate an intended or anticipated response through coloring to enhance communication.

Not all users with the same national language profile understand the subtleties of the meanings associated with different characters, text treatments, avatar gestures, and graphics. For example, not all users of National Language Support profile 100 understand that when a sentence is typed in all caps, that text treatment is deemed to be a heated or “flame” communication. In addition, as Internet communication conventions change, it would be advantageous to provide a National Language Support basis for generalizing the responses to different conventions.

National Language Support profile 100 also includes responses to content within other categories of analysis for the specific language and country profile. In general, within a particular language and region certain words and phrases have typical associated responses. For example, certain words by definition have a derogatory meaning, such as idiot, moron, and zit-faced. Other words, by definition are typically utilized in a strong tone, such as incompetent and horrible. Further, some languages include idioms that have associated general responses.

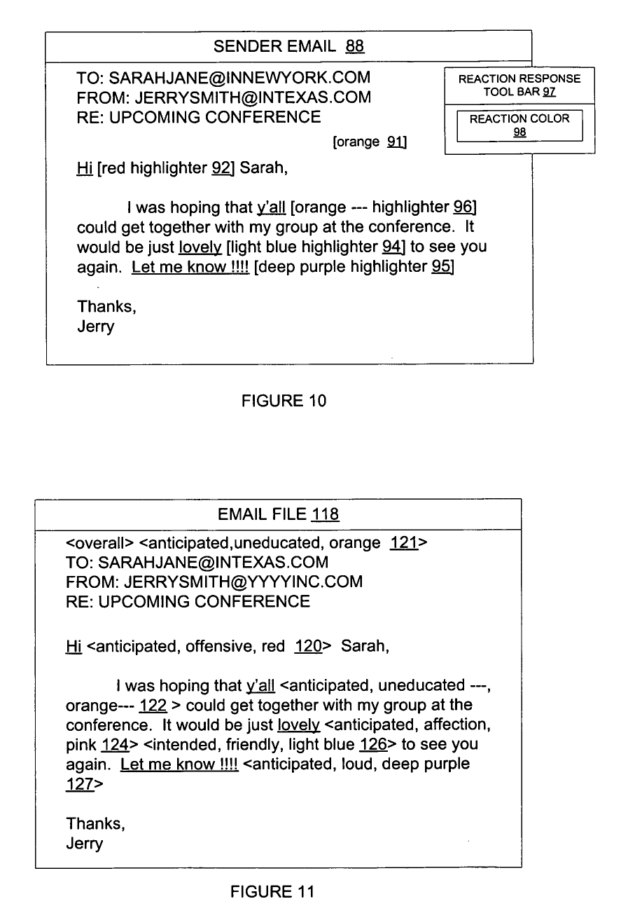

With reference now to FIG. 10, there is depicted an illustrative representation of a proposed e-mail in accordance with the method, system, and program of the present invention. As depicted, a sender e-mail 88 includes an example of a proposed communication by the sender. Proposed e-mail communications include the message the sender proposes to send to a particular recipient or recipients.

For purposes of the example, individual response profile 84 in FIG. 7 represents the individual response profile for the intended recipient, regional response profile 86 in FIG. 8 represents the regional response profile for the sender, and National Language Support profile 100 in FIG. 9 represents the National Language Support profile for the recipient.

Different colors preferably represent different types of reaction responses. Each sender or recipient may specify the colors that represent different responses or a standard color selection may be fixed for each type of response. In the example, the underlined portions of the content of the communication are highlighted by the color indicated in brackets following varying portions of the content. However, in alternate embodiments, alternate types of coloring of varying portions of the communication may be utilized. In addition, as an alternative to coloring, textual indicators of the response descriptions associated with the varying portions of the communications may be displayed in the communication.

Further, other types of coloring of sender e-mail 88 may be performed. In the example, an overall anticipated response is determined from the most intense response indicated for the communication. As will be further described, the anticipated response to the use of the word “y'all” is that the sender is extremely uneducated. The overall anticipated response in this example is indicated by shading the background of sender e-mail 88 with the color orange, which is associated with the “uneducated” response, as indicated at reference numeral 91.

The proposed greeting for the communication is “Hi Sarah.” As indicated at reference numeral 92, the “Hi” portion of the greeting is highlighted in red. The color red, for purposes of example, represents the anticipation that the recipient will be offended by the greeting.

Preferably, different shades of colors may be utilized to distinguish the intensities of responses. For example, as indicated at reference numeral 96, the word “y'all” is highlighted in a deeper orange in anticipation that the recipient will consider the sender extremely uneducated, rather than just uneducated, by the use of the word. The “−” marker indicates the deepness of the color to be used and the degree of feeling, where the deepness marked matches the degree of feeling indicated for the word “y'all” in individual response profile 84.

In addition to coloring words and the overall communication display area, other portions of sender e-mail may be colored. For example, the phrase “Let me know” is followed by “!!!!”. National Language Support profile 100 indicates that when multiple “!” are used, the phrase would be communicated louder or in an elevated voice. As indicated at reference numeral 95, a deep purple color is utilized to highlight the entire underlined phrase preceding the “!!!!”, providing an anticipation that the phrase will be interpreted by the recipient as a loudly expressed communication.

Where an anticipated response to the proposed e-mail is not the desired response by the sender, the sender may adjust the content of the proposed e-mail or the sender may adjust the coloring/reaction response associated with a portion of the e-mail to indicate an intended response. The sender's intended responses are preferably marked in the e-mail displayed to the recipient.

To indicate intended response to the proposed e-mail, the sender may deselect color highlighted areas and add other highlighted color areas in a color that represents the response intended. In particular, tool bar 97 includes a selectable tool 98 for reaction response highlighting. The sender selects the tool and a highlighting color. Advantageously, the colors are listed with associated reaction responses. Where a sender utilizes selectable tool 98, the highlighting indicates an intended response. Where a recipient utilizes selectable tool 98, the highlighting indicates an actual response.

In the example depicted, the sender has highlighted the word “lovely” indicated at reference numeral 94 with a light blue color to indicate friendship. The anticipated response to the word “lovely” is one of affection. By highlighting the word “lovely” in a color different from the color representing the anticipated response, the sender is applying the sender's intended meaning to the word. In the display of the e-mail to the recipient, the word “lovely” will be highlighted in light blue, such that the sender is enabled to dissipate any miscommunication about how the word should be interpreted. The sender also has the option of requesting an edit of the e-mail, where a word or phrase that better represents the sender's intent is suggested.

With reference now to FIG. 11, there is depicted an illustrative representation of a context searchable e-mail file stored in accordance with the method, system, and program of the present invention. As illustrated, e-mail file 118 is the stored file of sender e-mail 88 in FIG. 10. Advantageously, when sender e-mail 88 is stored, the coloring and reaction responses associated with the coloring within sender e-mail 88 are designated within e-mail file 118, such that e-mail file 118 is searchable according to color, reaction response, and other criteria.

In the example, tagging is associated with underlined portions of the content to indicate context for the communication, including reaction responses and colors associated with the reactions responses. In particular, the tagging indicates the type of reaction response (anticipated, intended, or actual), the identified response, and the color associated with the identified response. However, in alternate embodiments, other types of identifiers may be utilized to indicate context information for a communication.

As illustrated, the overall reaction response for e-mail file 118 is indicated at reference numeral 121, specifying an anticipated response of uneducated which is represented by orange coloring within the file. In other examples, the context for the greeting is indicated at reference numeral 120, the context for the word “y'all” is indicated at reference numeral 122, the context for the word “lovely” is indicated at reference numeral 124 (anticipated) and 126 (intended), and the context for the phrase preceding “!!!!” is indicated at reference numeral 127.

In particular, the tagging for the word “y'all” indicated at reference numeral 122 includes negative (−) markings indicating the intensity of the color and the identified response. Preferably the intensity of both the color and identified response are marked with matching indicators.

By tagging the overall file and selected portions of e-mail file 118 for storage, e-mail file 118 is searchable by reaction response and color associated with reaction response. For example, if a user requested a search for all communications including an intended reaction response of “friendly”, e-mail file 118 would be returned.

When a stored communication marked with context indictors is retrieved, the communication is preferably displayed to reflect those context indicators. For example, if e-mail file 118 is retrieved by a user, it is preferably displayed to the user in a similar output format as sender e-mail 88 in FIG. 10, wherein varying portions of the communication are highlighted by coloring indicating reaction responses.

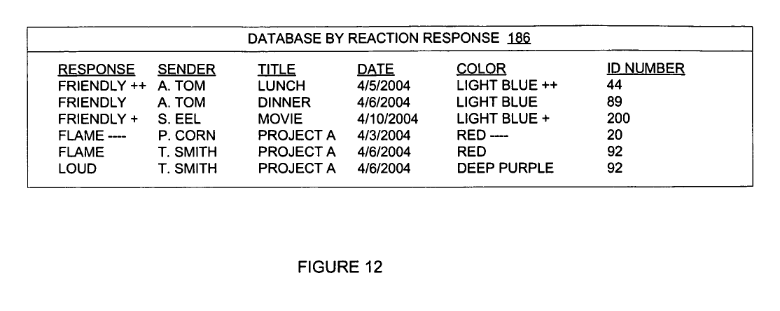

Referring now to FIG. 12, there is depicted an illustrative representation of a database sorted by reaction response in accordance with the method, system and program of the present invention. As depicted, database by reaction response 186 includes multiple communications stored by reaction response, sender, title, date, color, and ID number. The ID number is attached to a communication when stored to indicate the order of storage. Other fields may be added for each database entry.

In the example, the first three entries (ID numbers 44, 89, and 200) include communications with a reaction response that is “friendly”. If a user requested all communications with a reaction response that is “friendly” sent by “A. Tom”, the first two communications would be returned to the user.

The fourth and fifth entries (ID numbers 20 and 92) include communications with a reaction response that includes a “flame” context. The fifth and sixth entries (ID number 92) are the same communication, included in the database according to both the reaction response including a “flame” context and the reaction response of a “loud” context. Advantageously, when storing a communication by reaction response, each reaction response within the communication is searchable. In database by color 184, communications are similarly stored according to color, where each color indicated within the communication is searchable.

As illustrated, the intensity of each feeling, as indicated by positive (+) and negative (−) signs matches the intensity of coloring utilized. For example, the reaction response in the first entry has an intensity of a double positive and therefore the intensity in hue, transparency or other color attribute will be adjusted by a double positive value.

Reaction responses may be further specified by the type of reaction response (anticipated, intended, or actual), the response description, the color associated with the response, and the content associated with the response. For example, ID number entry 44 may be described as an anticipated response with a description of “friendly” and coloring of “light blue” in association with the overall content of the communication. In comparison, ID number entry 89 may be described as an intended response with a description of “friendly” and coloring of “light blue” in association with a particular paragraph of the content of the communication.

With reference now to FIG. 13, there is depicted a high level logic flowchart of a process and program for context-based searching and storage of communications. As depicted, the process starts at block 150 and thereafter proceeds to block 152. The process steps may be performed by a server or other computing systems enabled to perform analysis of reaction responses.

Block 152 illustrates a determination as to whether an input is received. If a request for reaction response analysis is received, the process passes to block 154. If a communication for storage is detected, the process passes to block 166. If a request to search the stored communications by a search criteria is received, then the process passes to block 170.

First, a request for reaction response analysis may be initiated by a sender, a recipient, or a process that automatically performs reaction response analysis. In providing a reaction response analysis, block 154 depicts determining at least one of a sender or a recipient identity. In determining an identity, a screen name, identification number, or other identifier may be accessed. Preferably a profile associated with the identity is also accessible. A profile may include personal information and characteristics about the sender or recipient. Both the sender and recipient may be identified, such that the reaction response analysis may yield both anticipated responses of the recipient and intended responses of the sender.

Next, block 156 illustrates accessing relevant response databases according to the sender and/or recipient identity. The relevant response databases may include reaction responses stored individually based, regionally based, National Language Support based, characteristic based, business based and according to other categories of basis.

Thereafter, block 158 depicts analyzing the content of the communication in view of the reaction responses from the relevant response databases. In particular, analysis may include comparing words, phrases, sentences, symbols, graphics, sounds, and other content of the communication with the databases having indications of intended and anticipated responses to varying types of content. Further, in particular, a sender or recipient may designate preferences for the types of analysis to be performed within a communication. For example, a sender may request for words, phrases and sentences to be analyzed, but not request for symbols and text attachments to be analyzed.

Next, block 160 illustrates designating the reaction responses for the content according to analysis preferences. Within the content of a communication, tags, markers or other command indicators may be added or notated that specify the reaction response associated with each of the portions of the content requested for analysis by the sender or recipient. For example, a message in extensible mark-up language (XML) format may be broken into nodes where nodes with analyzed content are specified by attributes intended to show reaction responses.

Thereafter, block 162 depicts adjusting the color of at least one portion of the communication to represent a reaction response for that at least one portion, and the process ends. Advantageously the requester specifies preferences for whether coloring for each reaction response should be displayed, coloring for the overall reaction response should be displayed, or coloring for specified types of reaction responses should be displayed. Where a requester specifies a request for the overall reaction response, the coloring may be adjusted for the window or other display interface in which the communication is displayed. In particular, if no reaction response is determined for a communication, no coloring may be added, however another type of graphical indicator may indicate that no reaction response is determined.

In particular, the color of the communication may be adjusted by the messaging server or may be adjusted at the computing system utilized by the sender or recipient. A messaging server specifies colors associated with each type of reaction response, and adjusts the coloring of communications according to these specified colors. At the sender or recipient computing system, the sender or recipient may individually specify which colors to associate with each reaction response. A sender may further specify colors of portions of a communication that are to be displayed in the communication to the recipient

To store a communication, block 166 depicts marking the communication with the context determined for the communication. In particular, the anticipated, intended and actual reaction responses are preferably marked within the communication. Next, block 168 illustrates storing the communication by color, reaction responses, sender, recipient, date, time, topic, and other relevant categories, and the process ends. In particular, as a communication is passed from one user to another and additional reaction responses are added, the stored communication is preferably updated to include the changes to the communication.

Where a request to search for communications according to search criteria is received, block 170 depicts filtering the stored communications by the search criteria. The selection of communications matching the search criteria are filtered out and block 172 illustrates controlling the output of the selection of communication filtered by the search. Block 174 depicts rendering a particular communication from among the selected communications with a displayable attribute indicating the reaction responses within the communication, and the process ends. In particular, coloring may be utilized as the displayable attribute indicating reaction responses in the rendered communication, however other displayable attributes, such as text, may indicate the reaction responses for the communication.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular types of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

While the invention has been particularly shown and described with reference to a preferred embodiment, it will be understood by those skilled in the art that various changes in form and detail may be made therein without departing from the spirit and scope of the invention.

What is claimed is:

1. A method for storing context searchable communications, comprising:
analyzing varying portions of content of a communication to identify a particular reaction response associated with each of said varying portions of said content; and
associating a particular displayable attribute with each of said varying portions of said content to indicate said identified reaction response; and
storing each of said varying portions of said content for said communication with each of said identified reaction responses and each of said associated displayable attributes in a database searchable by context comprising at least one of a reaction response and a displayable attribute.

2. The method for storing context searchable communications according to claim 1, wherein each of said varying portions comprise at least one from among a word, a phrase, a sentence, a paragraph, a topic, a subject line, a mood, an urgency indicator, a greeting, a closing, an icon, a graphic, an avatar gesture, a sound clip, a video clip, an attached document, and all said content.

3. The method for storing context searchable communications according to claim 1, wherein each of said associated displayable attributes comprises at least one from among a color, a text treatment, a style treatment, and a graphical element.

4. The method for storing context searchable communications according to claim 1, wherein each of said reaction responses comprises at least one from among an anticipated response of an intended recipient of said communication, an intended response of a sender of said communication, and an actual response of said intended recipient to said communication.

5. The method for storing context searchable communications according to claim 1, further comprising:
retrieving said communication from said searchable database; and
rendering said communication with said each of said displayable attributes displayed in said content of said communication.

6. The method for storing context searchable communications according to claim 1, further comprising:
filtering said searchable database according to a search criteria comprising at least one of a reaction response and a displayable attribute to retrieve a selection of communications stored within said searchable database meeting said search criteria.

7. The method for storing context searchable communications according to claim 1, further comprising:
searching said searchable database for a particular reaction response by at least one of a sender, a recipient, a date, a time, and a topic.

8. The method for storing context searchable communications according to claim 1, further comprising:
in response to detecting an amendment to said communication, updating said stored communication in said searchable database with said amendment and an amended reaction response associated with said amendment.

9. The method for storing context searchable communications according to claim 1, further comprising:
analyzing each of said varying portions of said content with entries from at least one response database of reaction responses associated with a plurality of categories of communication content.

10. The method for storing context searchable communications according to claim 9, wherein said at least one response database of reaction responses comprises at least one from among an individual response database, a regional response database, a National Language Support response database, a business response database, and a characteristics response database.

11. The method for storing context searchable communications according to claim 1, wherein said communication is at least one from among a document, an electronic communication, a voice communication, a video communication, and a graphical communication.

12. A system for storing context searchable communications, comprising:
a computing system communicatively connected to a network;
said computing system further comprising:
means for analyzing varying portions of content of a communication to identify a particular reaction response associated with each of said varying portions of said content; and
means for associating a particular displayable attribute with each of said varying portions of said content to indicate said identified reaction response; and
means for storing each of said varying portions of said content for said communication with each of said identified reaction responses and each of said associated displayable attributes in a database searchable by context comprising at least one of a reaction response and a displayable attribute.

13. The system for storing context searchable communications according to claim 12, further comprising:
means for associating a particular displayable attribute with each of said varying portions comprising at least one from among a word, a phrase, a sentence, a paragraph, a topic, a subject line, a mood, an urgency indicator, a greeting, a closing, an icon, a graphic, an avatar gesture, a sound clip, a video clip, an attached document, and all said content.

14. The system for storing context searchable communications according to claim 12, further comprising:
means for associating a particular displayable attribute comprising at least one from among a color, a text treatment, a style treatment, and a graphical element.

15. The system for storing context searchable communications according to claim 12, further comprising:
means for indicating each of said reaction responses comprising at least one from among an anticipated response of an intended recipient of said communication, an intended response of a sender of said communication, and an actual response of said intended recipient to said communication.

16. The system for storing context searchable communications according to claim 12, further comprising:
means for retrieving said communication from said searchable database; and
means for rendering said communication with said each of said displayable attributes displayed in said content of said communication.

17. The system for storing context searchable communications according to claim 12, further comprising:
means for filtering said searchable database according to a search criteria comprising at least one of a reaction response and a displayable attribute to retrieve a selection of communications stored within said searchable database meeting said search criteria.

18. The system for storing context searchable communications according to claim 12, further comprising:
means for searching said searchable database for a particular reaction response by at least one of a sender, a recipient, a date, a time, and a topic.

19. The system for storing context searchable communications according to claim 12, further comprising:
means for updating said stored communication in said searchable database with said amendment and an amended reaction response associated with said amendment, in response to detecting an amendment to said communication.

20. The system for storing context searchable communications according to claim 12, further comprising:
means for analyzing each of said varying portions of said content with entries from at least one response database of reaction responses associated with a plurality of categories of communication content.

21. The system for storing context searchable communications according to claim 20, further comprising:
means for comparing said varying portions of said content with said at least one responses database comprising at least one from among an individual response database, a regional response database, a National Language Support response database, a business response database, and a characteristics response database.

22. The system for storing context searchable communications according to claim 12, wherein said communication is at least one from among a document, an electronic communication, a voice communication, a video communication, and a graphical communication.

23. A computer program product for storing context searchable communications, comprising:
a recording medium;
means, recorded on said recording medium, for analyzing varying portions of content of a communication to identify a particular reaction response associated with each of said varying portions of said content; and
means, recorded on said recording medium, for associating a particular displayable attribute with each of said varying portions of said content to indicate said identified reaction response; and
means, recorded on said recording medium, for storing each of said varying portions of said content for said communication with each of said identified reaction responses and each of said associated displayable attributes in a database searchable by context comprising at least one of a reaction response and a displayable attribute.

24. The computer program product for storing context searchable communications according to claim 23, further comprising:
means, recorded on said recording medium, for associating a particular displayable attribute with each of said varying portions comprising at least one from among a word, a phrase, a sentence, a paragraph, a topic, a subject line, a mood, an urgency indicator, a greeting, a closing, an icon, a graphic, an avatar gesture, a sound clip, a video clip, an attached document, and all said content.

25. The computer program product for storing context searchable communications according to claim 23, further comprising:
means, recorded on said recording medium, for associating a particular displayable attribute comprising at least one from among a color, a text treatment, a style treatment, and a graphical element.

26. The computer program product for storing context searchable communications according to claim 23, further comprising:
means, recorded on said recording medium, for indicating each of said reaction responses comprising at least one from among an anticipated response of an intended recipient of said communication, an intended response of a sender of said communication, and an actual response of said intended recipient to said communication.

27. The computer program product for storing context searchable communications according to claim 23, further comprising:
means, recorded on said recording medium, for retrieving said communication from said searchable database; and
means, recorded on said recording medium, for rendering said communication with said each of said displayable attributes displayed in said content of said communication.

28. The computer program product for storing context searchable communications according to claim 23, further comprising:
means, recorded on said recording medium, for filtering said searchable database according to a search criteria comprising at least one of a reaction response and a displayable attribute to retrieve a selection of communications stored within said searchable database meeting said search criteria.

29. The computer program product for storing context searchable communications according to claim 23, further comprising:
means, recorded on said recording medium, for searching said searchable database for a particular reaction response by at least one of a sender, a recipient, a date, a time, and a topic.

30. The computer program product for storing context searchable communications according to claim 23, further comprising:
means, recorded on said recording medium, for updating said stored communication in said searchable database with said amendment and an amended reaction response associated with said amendment, in response to detecting an amendment to said communication.

31. The computer program product for storing context searchable communications according to claim 23, further comprising:
means, recorded on said recording medium, for analyzing each of said varying portions of said content with entries from at least one response database of reaction responses associated with a plurality of categories of communication content.

32. The computer program product for storing context searchable communications according to claim 31, further comprising:
means, recorded on said recording medium, for comparing said varying portions of said content with said at least one responses database comprising at least one from among an individual response database, a regional response database, a National Language Support response database, a business response database, and a characteristics response database.

33. A method for searching communications by context, comprising:
filtering a plurality of communications stored in a searchable database by search criteria comprising at least one of a particular reaction response and an associated particular displayable attribute; and
rendering a selection from among said plurality of communications meeting said search criteria with said associated displayable attribute displayed within the content of said selection of communications.

34. A method for storing context-based communications, comprising:
determining a context for a communication, wherein said context indicates non-verbal and verbal communication responses; and
storing said communication with said context in a database searchable by non-verbal and verbal communication responses.

35. The method for storing context-based communications according to claim 34, further comprising:
associating at least one displayable attribute with said context for said communication.

36. The method for storing context-based communication according to claim 35, further comprising:
storing said communication with said at least one displayable attributed in a database searchable by displayable attributes.

37. The method for storing context-based communications according to claim 34, wherein said verbal and non-verbal communication responses include at least one of anticipated responses by a recipient of said communication, intended responses of a sender of said communication, and actual responses by said recipient of said communication.

38. A method for storing communications, comprising:
analyzing varying portions of content of a communication to identify a particular reaction response associated with each of said varying portions of said content; and
associating a color with each of said varying portions of said content to indicate said identified reaction response; and
storing each of said varying portions of said content for said communication with each of said identified reaction responses and each of said colors in a database searchable by context comprising at least one of reaction responses and colors.
